(19) United States
(12) Patent Application Publication
(10) Pub. No.: US 2012/0181410 A1
(43) Pub. Date: Jul. 19, 2012

(54) STAND FOR PORTABLE ELECTRONIC DEVICE AND FOLDING METHOD THEREOF

(75) Inventors: YUAN-CHIH KU, Tu-Cheng (TW); CHING-MIN LIN, Tu-Cheng (TW); HSIN-YUNG YANG, Tu-Cheng (TW); TZU-CHENG YU, Santa Clara, CA (US)

(73) Assignee: CHI MEI COMMUNICATION SYSTEMS, INC., New Taipei (TW)

(21) Appl. No.: 13/036,120

(22) Filed: Feb. 28, 2011

(30) Foreign Application Priority Data
Jan. 18, 2011 (TW) 100101715

(51) Int. Cl. F16M 11/22; B23P 17/00

(52) U.S. Cl. 248/453; 29/428

(57) ABSTRACT

A stand for supporting a portable electronic device is constructed by a foldable body. The foldable body includes three parallel fold lines dividing the foldable body into a first supporting portion, a second supporting portion, a connection portion, and a bottom portion. One end of the first support portion is fixed on the bottom portion. The first supporting portion, the second supporting portion, and the bottom portion forming a triangular structure. A slot is defined in the connection portion adjacent to the bottom portion. A resisting portion is formed on the bottom portion adjacent to the connection portion. The resisting portion extends through the slot.

### BACKGROUND

### 1. Technical Field

This disclosure relates to stands for portable electronic devices, and particularly, to a stand, which can be folded or unfolded and a folding method thereof.

Nowadays, portable electronic devices generally have multimedia functions. Users can read eBooks or watch videos using the portable electronic devices. To comfortably read an eBook or watch a video, a stand may be needed to support the portable electronic device at an angle. However, conventional stands are big or heavy, making them cumbersome to carry.

Therefore, there is room for improvement within the art.

### BRIEF DESCRIPTION OF THE DRAWINGS

Many aspects of the stand can be better understood with reference to the following drawings. The components in the drawings are not necessarily drawn to scale, the emphasis instead being placed upon clearly illustrating the principles of the stand.

FIG. 1 is a folded, schematic view of a stand, in accordance with an exemplary embodiment.

FIG. 2 is an unfolded view of the stand shown in FIG. 1.

FIG. 3 is a schematic view of the stand shown in FIG. 1, showing the stand being folded.

FIG. 4 is similar to FIG. 3, showing the stand being further folded.

FIG. 5 is schematic view of the stand shown in FIG. 1, showing a portable electronic device supported by the stand.

### DETAILED DESCRIPTION

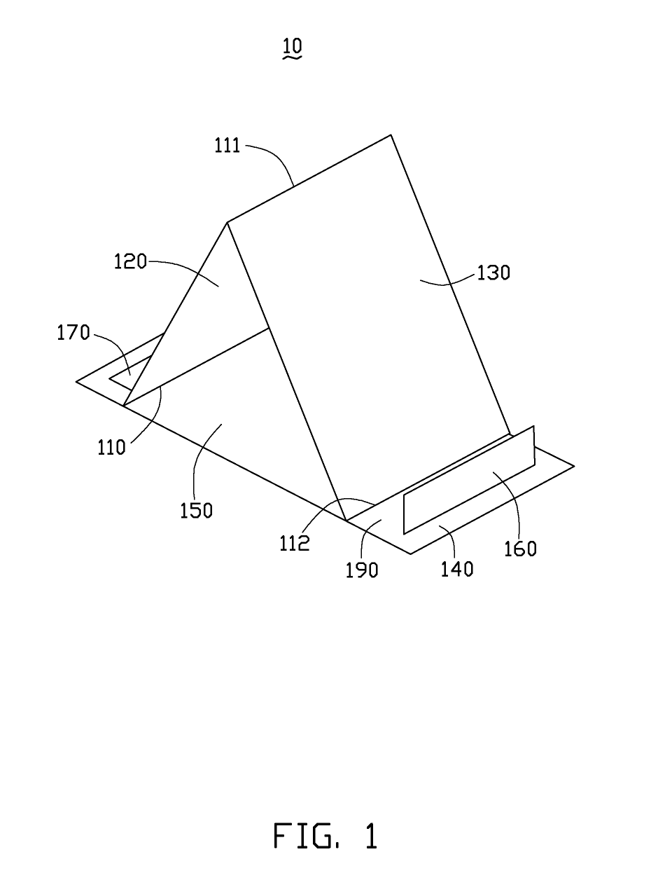

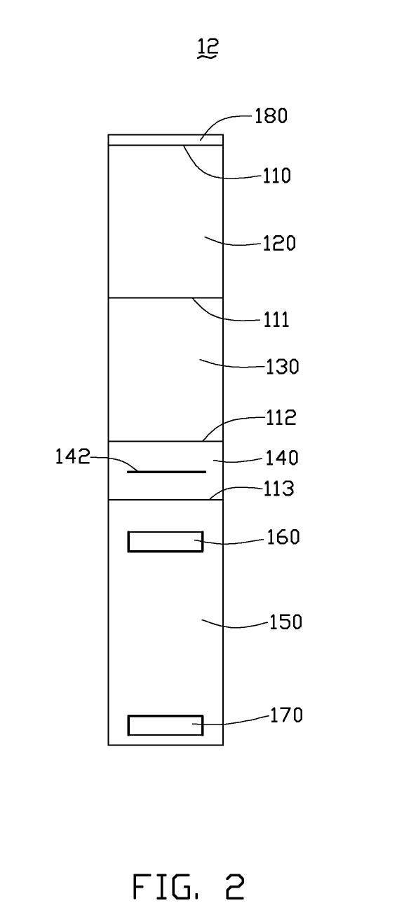

FIG. 1 shows an exemplary embodiment of a stand 10 for portable electronic devices. Also referring to FIG. 2, a foldable body 12 constructs the stand 10, material for the foldable body 12 may be paper, plastic, metal or wood. The foldable body 12 may be partially hollow to form various patterns, which can improve appearance and reduce the weight thereof.

The foldable body 12 includes four parallel fold lines 110, 111, 112, 113, which divide the foldable body 12 into five portions: a latching portion 180, a first supporting portion 120, a second supporting portion 130, a connection portion 140, and a bottom portion 150. The first supporting portion 120 and the second supporting portion 130 are each longer than the bottom portion 150.

A resisting portion 160 is formed on the bottom portion 150 adjacent to the connection portion 140. In this exemplary embodiment, the resisting portion 160 is formed by partially cutting the bottom portion 150, having an edge adjacent to the connection portion 140, near where the connection portion 140 is connected to the bottom portion 150.

The connection portion 140 defines a slot 142 adjacent to the bottom portion 150. In this exemplary embodiment, the slot 142 is parallel to the fold lines 111, 112, 113.

A fixing portion 170 is formed on the bottom portion 150. In this exemplary embodiment, the fixing portion 170 is formed by means of partially cutting the bottom portion 150, near where fixing portion 170 is connected to the bottom portion 150.

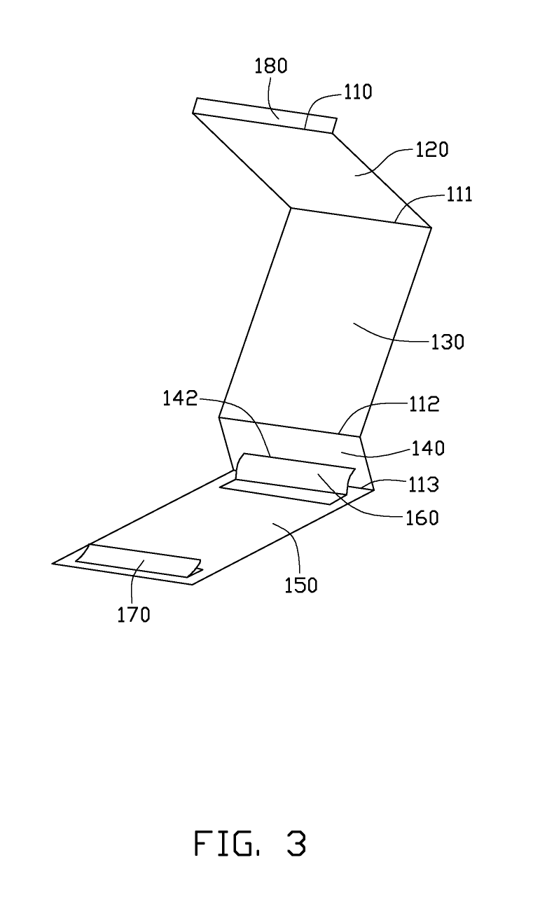

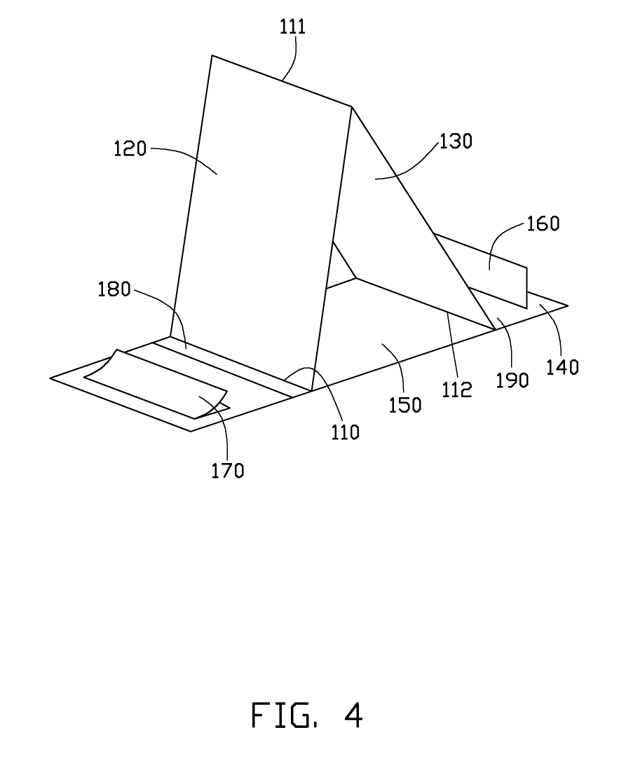

To fold the foldable body 12, referring to FIGS. 3 and 4, the foldable body 12 is folded along the fold lines 111, 112, 113. The resisting portion 160 extends through the slot 142. The latching portion 180 is inserted into the fixing portion 170. At this time, the first supporting portion 120, the second supporting portion 130 and the bottom portion 150 form a triangular structure. A space 190 is formed between the resisting portion 160 and the second supporting portion 130.

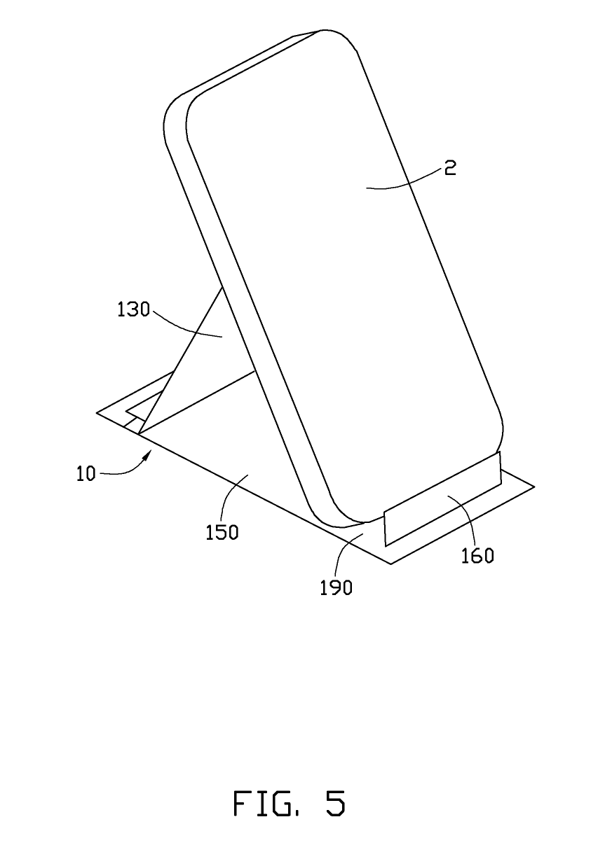

Referring to FIG. 5, a portable electronic device 2 is set on the stand 10, with one end inserted into the space 190. The first supporting portion 120 supports the portable electronic device 2, and users can comfortably read eBooks or watch videos using the portable electronic device 200.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A stand for supporting a portable electronic device, the stand formed by a foldable body, the foldable body comprising:
three parallel fold lines dividing the foldable body into a first supporting portion, a second supporting portion, a connection portion and a bottom portion; when the foldable body is folded, one end of the first supporting portion is fixed on the bottom portion, and the first supporting portion, the second supporting portion and the bottom portion form a triangular structure;
a slot defined in the connection portion adjacent to the bottom portion; and
a resisting portion formed on the bottom portion adjacent to the connection portion, the resisting portion extending through the slot when the foldable body is folded.

2. The stand as claimed in claim 1, wherein the resisting portion is formed by partially cutting the bottom portion, with an edge resisting portion adjacent to where the connection portion is connected to the bottom portion.

3. The stand as claimed in claim 1, wherein the slot is parallel to the fold lines.

4. The stand as claimed in claim 1, wherein the foldable body further comprises a latching portion at one end of the first supporting portion, and another fold line is formed between the latching portion and the first supporting portion.

5. The stand as claimed in claim 4, wherein the fixing portion is formed by partially cutting the bottom portion at one end, with an edge of the fixing portion connected to the bottom portion.

6. The stand as claimed in claim 1, wherein the material of the foldable body is selected from a group of paper, plastic, metal and wood.

7. A method for folding a stand for portable electronic device, comprising steps of:
folding a foldable body, along three parallel fold lines which divides the foldable body into a first supporting portion, a second supporting portion, a connection portion and a bottom portion; forming an aperture in the connection portion, forming a resisting portion on the bottom portion adjacent to the connection portion;
folding the foldable body along the fold lines;
inserting the resisting portion into the aperture; and
fixing one end of the first supporting portion on the bottom portion, the first supporting portion, the second supporting portion and the bottom portion forming a triangular structure.

8. The method as claimed in claim 7, wherein the resisting portion is formed by partially cutting the bottom portion, with an edge of the resisting portion adjacent to where the connection portion is connected to the bottom portion.

9. The method as claimed in claim 7, wherein the slot is paralleled to the fold lines.

10. The method as claimed in claim 7, wherein the foldable body further comprises a latching portion at one end of the first supporting portion, and another fold line is formed between the latching portion and the first supporting portion.

11. The method as claimed in claim 10, wherein the fixing portion is formed by partially cutting the bottom portion at one end, with an edge of the fixing portion connected to the bottom portion.

12. The method as claimed in claim 11, wherein the foldable body is partially hollow to form a pattern.

13. The method as claimed in claim 12, wherein the material of the foldable body is selected from a group of paper, plastic, metal and wood.
